(19) United States
(12) Patent Application Publication
(10) Pub. No.: US 2007/0220337 A1
(43) Pub. Date: Sep. 20, 2007

(54) Microcomputer

(76) Inventors: Yutaka Itoh, Kyoto (JP); Yasuhiro Nagira, Osaka (JP)

Correspondence Address: MCDERMOTT WILL & EMERY LLP, 600 13TH STREET, NW, WASHINGTON, DC, 20005-3096, US

(21) Appl. No.: 11/717,644

(22) Filed: Mar. 14, 2007

(30) Foreign Application Priority Data
Mar. 14, 2006 (JP) 2006-068658

(51) Int. Cl. G06F 11/00

(52) U.S. Cl. 714/30

(57) ABSTRACT

A microcomputer includes: a memory; a CPU which decodes memory data stored in the memory to execute an instruction; a debug control section for instructing the microcomputer to perform a debug operation according to an instruction from an external debug instruction device which is connected to the microcomputer; and an authentication section for performing, when the external debug instruction device is connected to the microcomputer that is in a normal operation, an authentication as to whether to allow the debug operation to be performed, wherein the memory data of the memory is prevented from being read out to outside of the microcomputer during a period between connection of the external debug instruction device to the microcomputer and success of the authentication by the authentication section.

### CROSS-REFERENCE TO RELATED APPLICATIONS

This application claims priority under 35 U.S.C. §119(a) on Japanese Patent Application No. 2006-068658 filed on Mar. 14, 2006, the entire contents of the specification, drawings and claims of which are hereby incorporated by reference.

### BACKGROUND OF THE INVENTION

1. Field of the Invention

The present invention relates to a technique for protecting programs and data stored in a nonvolatile memory, or the like, incorporated in a microcomputer against fraudulent read attempts.

2. Description of the Prior Art

Some microcomputers have a debug function and an authentication function (see Japanese Laid-Open Patent Publication No. 2000-347942).

After reset, such a microcomputer enters a state where debugging of a program stored in a memory is impossible, i.e., a secured state where information stored in the memory of the microcomputer cannot be read by an external device, and then, success of authentication enables debugging.

However, such a microcomputer needs to be reset for starting debagging, and therefore, the debagging process of investigating the cause of an error caused in the midst of a normal operation of the microcomputer mounted on a substrate is difficult to perform. This is because, in the debugging process, the conditions in which the error occurred have been erased by resetting.

### SUMMARY OF THE INVENTION

In view of the above circumstances, an objective of the present invention is to provide a microcomputer wherein debugging can be started not with the post-reset conditions but with the normal operation conditions while information stored in a memory are protected against external read attempts during a period between connection of a debugger to the microcomputer and success of authentication.

To achieve the above objective, the first embodiment of the present invention is directed to a microcomputer including: a memory; a CPU which decodes memory data stored in the memory to execute an instruction; a debug control section for instructing the microcomputer to perform a debug operation according to an instruction from an external debug instruction device which is connected to the microcomputer; and an authentication section for performing, when the external debug instruction device is connected to the microcomputer that is in a normal operation, an authentication as to whether to allow the debug operation to be performed, wherein the memory data of the memory is prevented from being read out to outside of the microcomputer during a period between connection of the external debug instruction device to the microcomputer and success of the authentication by the authentication section.

According to the first embodiment, authentication is performed after the external debug instruction device is connected to the microcomputer in the midst of the normal operation. Therefore, debugging is possible with the normal operation conditions. In addition, memory data of the memory is not read out by an external device outside the microcomputer before success of authentication.

The second embodiment of the present invention is directed to the microcomputer of the first embodiment, further including a memory control section which prevents the memory data from being output from the memory within the microcomputer during a period between connection of the external debug instruction device to the microcomputer that is in a normal operation and success of the authentication by the authentication section.

The third embodiment of the present invention is directed to the microcomputer of the second embodiment, wherein the memory control section causes the memory to output predetermined data irrespective of the memory data, thereby preventing the memory data from being output from the memory within the microcomputer.

According to the second and third embodiments, the memory data of the memory is not output from the memory itself and is therefore surely prevented from being read out to the outside of the microcomputer.

The fourth embodiment of the present invention is directed to the microcomputer of the third embodiment, wherein the predetermined data is data which is supposed to be decoded by the CPU into an instruction for branching to a region where a relative address is 0.

According to the fourth embodiment, during a period between connection of the external debug instruction device to the microcomputer and success of the authentication, a branch instruction for branching to an address of the memory that the CPU has been accessing at the time of connection of the external debug instruction device is output from the memory and continuously executed by the CPU. During this period, the memory contents of the memory are prevented from being read out, and the value of the program counter is maintained at the same value. Therefore, after success of authentication, debugging can be started from the address of the memory that the CPU has been accessing at the time when the external debug instruction device is connected to the microcomputer.

The fifth embodiment of the present invention is directed to the microcomputer of the fourth embodiment, further including a branch instruction detection section for detecting execution of a branch instruction by the CPU, wherein after connection of the external debug instruction device to the microcomputer, the memory control section causes the memory to output the predetermined data during a period between detection of a branch instruction by the branch instruction detection section and success of the authentication.

According to the fifth embodiment, the CPU executes data which is supposed to be decoded by the CPU into an instruction for branching to a region where the relative address is 0, whereby disorder of a pipeline operation which would change the instruction execution timing can be avoided.

The sixth embodiment of the present invention is directed to the microcomputer of the fourth embodiment, further comprising a protected region access detection section for detecting an access to a predetermined protected region of the memory, wherein after connection of the external debug instruction device to the microcomputer, the memory control section causes the memory to output the predetermined data after detection of an access to the protected region.

According to the sixth embodiment, after the external debug instruction device is connected to the microcomputer, the CPU can execute an operation code which needs no protection during a period when a region of the memory other than the protected region is accessed. After the protected region is accessed, protection against fraudulent read attempts on the memory data of the memory is started. The data stored in the protected region is prevented from being read out to the outside of the microcomputer.

The seventh embodiment of the present invention is directed to the microcomputer of the sixth embodiment, wherein an instruction of an interrupt process is stored in a region of the memory other than the protected region.

According to the seventh embodiment, the CPU can execute the interrupt process even during an authentication procedure between connection of the external debug instruction device to the microcomputer and success of the authentication.

The eighth embodiment of the present invention is directed to the microcomputer of the fourth embodiment, further comprising an interrupt control section for masking an interrupt request signal input to the CPU during a period when the memory control section causes the memory to output the predetermined data.

According to the eighth embodiment, the CPU cannot perform an interrupt operation during a period when the memory control section causes the memory to output the predetermined data. However, absence of the interrupt process can be avoided because an interrupt request itself is masked to be left unaccepted.

The ninth embodiment of the present invention is directed to the microcomputer of the third embodiment, wherein the predetermined data is data which is supposed to be decoded by the CPU into an instruction indicative that nothing is to be executed.

The tenth embodiment of the present invention is directed to the microcomputer of the third embodiment, further comprising a direct memory access controller which accesses the memory without the intervention of the CPU, wherein when the direct memory access controller accesses the memory during the period between connection of the external debug instruction device to the microcomputer and success of the authentication, the memory control section causes the memory to output the predetermined data.

According to the tenth embodiment, protection of the memory data of the memory against fraudulent read attempts is started after the direct memory access controller starts accessing the memory. Therefore, reading of the memory data of the memory by the direct memory access controller is infallibly prevented.

The eleventh embodiment of the present invention is directed to the microcomputer of the second embodiment, wherein after connection of the external debug instruction device to the microcomputer, the memory control section prevents the memory data from being output from the memory within the microcomputer after a predetermined timing.

The twelfth embodiment of the present invention is directed to the microcomputer of the eleventh embodiment, wherein the predetermined timing is a timing when discontinuity in execution of a series of instructions becomes acceptable.

The thirteenth embodiment of the present invention is directed to the microcomputer of the twelfth embodiment, wherein the timing when discontinuity in execution of a series of instructions becomes acceptable is a timing when an interrupt request signal to the CPU is not masked.

The fourteenth embodiment of the present invention is directed to the microcomputer of the twelfth embodiment, wherein the predetermined timing is a timing when the CPU executes a branch instruction.

According to the eleventh through fourteenth embodiments, interruption in the midst of the execution of a series of instructions which should be continuously executed in a pipeline process is prevented.

The fifteenth embodiment of the present invention is directed to the microcomputer of the eleventh embodiment, wherein the predetermined timing is a timing when the CPU accesses a predetermined protected region of the memory.

According to the fifteenth embodiment, after the external debug instruction device is connected to the microcomputer, the CPU can execute an operation code which needs no protection during a period when a region of the memory other than the protected region is accessed. After the protected region is accessed, protection against fraudulent read attempts on the memory data of the memory is started. The data stored in the protected region is prevented from being read out to the outside of the microcomputer.

The sixteenth embodiment of the present invention is directed to the microcomputer of the eleventh embodiment, further comprising a direct memory access controller which accesses the memory without the intervention of the CPU, wherein the predetermined timing is a timing when the direct memory access controller starts accessing the memory.

According to the sixteenth embodiment, protection of the memory data of the memory against fraudulent read attempts is started after the direct memory access controller starts accessing the memory. Therefore, reading of the memory data of the memory by the direct memory access controller is infallibly prevented.

The seventeenth embodiment of the present invention is directed to the microcomputer of the second embodiment, wherein after connection of the external debug instruction device to the microcomputer, the memory control section prevents the memory data from being output from the memory within the microcomputer at every predetermined timing.

The eighteenth embodiment of the present invention is directed to the microcomputer of the seventeenth embodiment, wherein the predetermined timing is a timing when the CPU accesses a predetermined protected region of the memory.

According to the eighteenth embodiment, after the external debug instruction device is connected to the microcomputer, the CPU can execute an operation code which needs no protection during a period when a region of the memory other than the protected region is accessed. During a period when the protected region is accessed, the memory data of the memory is protected against fraudulent read attempts. The data stored in the protected region is prevented from being read out to the outside of the microcomputer.

The nineteenth embodiment of the present invention is directed to the microcomputer of the eighteenth embodiment, wherein in a first read cycle after connection of the external debug instruction device to the microcomputer that is in a normal operation, the memory control section causes the memory to output, in substitution for the memory data, data which is supposed to be decoded by the CPU into an instruction for branching to a predetermined subroutine.

According to the nineteenth embodiment, in the first read cycle after connection of the external debug instruction device to the microcomputer, the CPU pushes to a stack an address that the CPU is currently accessing.

The twentieth embodiment of the present invention is directed to the microcomputer of the nineteenth embodiment, wherein a last instruction of the predetermined subroutine is a return instruction for returning a return address from a stack to a program counter.

According to the twentieth embodiment, the return address which has been pushed to the stack is returned to the program counter after success of authentication. Therefore, debugging can be started from an address that the CPU has been accessing at the time of connection of the external debug instruction device to the microcomputer.

The twenty-first embodiment of the present invention is directed to the microcomputer of the eighteenth embodiment, wherein when the external debug instruction device is connected to the microcomputer that is in a normal operation, the CPU executes an interrupt process.

According to the twenty-first embodiment, when the external debug instruction device is connected to the microcomputer, the CPU starts an interrupt process and, meanwhile, pushes to the stack an address that the CPU is currently accessing.

The twenty-second embodiment of the present invention is directed to the microcomputer of the twenty-first embodiment, wherein a last instruction of the interrupt process is a return instruction for returning a return address from a stack to a program counter.

According to the twenty-second embodiment, the return address which has been pushed to the stack is returned to the program counter after success of authentication. Therefore, debugging can be started from an address that the CPU has been accessing at the time of connection of the external debug instruction device to the microcomputer.

The twenty-third embodiment of the present invention is directed to the microcomputer of the twenty-first embodiment, wherein the interrupt which occurs in the CPU is a non-maskable interrupt.

According to the twenty-third embodiment, an interrupt process which occurs at the time of connection of the external debug instruction device to the microcomputer is infallibly executed.

The twenty-fourth embodiment of the present invention is directed to the microcomputer of the seventeenth embodiment, further comprising a direct memory access controller which accesses the memory without the intervention of the CPU, wherein the predetermined timing is a timing when the direct memory access controller accesses the memory.

According to the twenty-fourth embodiment, the memory data of the memory is protected against fraudulent read attempts when the direct memory access controller accesses the memory. Therefore, even in a period between connection of the external debug instruction device to the microcomputer and success of authentication, the CPU can retrieves an operation code of the memory to execute the resultant instruction as long as the direct memory access controller is not accessing the memory.

The twenty-fifth embodiment of the present invention is directed to the microcomputer of the second embodiment, further comprising a protected region access detection section for detecting an access to a predetermined protected region of the memory, wherein after connection of the external debug instruction device to the microcomputer, the memory control section prevents memory data stored in the protected region from being output from the memory within the microcomputer during a period when an access to the protected region is detected.

According to the twenty-fifth embodiment, after the external debug instruction device is connected to the microcomputer, the CPU can execute an operation code which needs no protection during a period when a region of the memory other than the protected region is accessed. During a period when the protected region is accessed, the memory data of the memory is protected against fraudulent read attempts. The data stored in the protected region is prevented from being read out to the outside of the microcomputer.

The twenty-sixth embodiment of the present invention is directed to the microcomputer of the second embodiment, wherein an interrupt request signal input to the CPU is masked during the period between connection of the external debug instruction device to the microcomputer that is in a normal operation and success of the authentication.

According to the twenty-sixth embodiment, the interrupt request signal is not input to the CPU during a period when the memory data of the memory is protected against fraudulent read attempts. Therefore, absence of an interrupt process which would occur contrary to the signal from the CPU indicative of acceptance of the interrupt can be avoided.

The twenty-seventh embodiment of the present invention is directed to the microcomputer of the first embodiment, wherein the debug control section stops an operation of the CPU during a period between connection of the external debug instruction device to the microcomputer that is in a normal operation and success of the authentication.

According to the twenty-seventh embodiment, the CPU stops the operation during a period between connection of the external debug instruction device to the microcomputer and success of the authentication. Therefore, before success of authentication, the memory data of the memory is not output to the outside of the microcomputer through execution of an instruction by the CPU. During this period, the value of the program counter is maintained at the same value. Therefore, after success of authentication, debugging can be started from an address of the memory that the CPU has been accessing at the time of connection of the external debug instruction device to the microcomputer.

The twenty-eighth embodiment of the present invention is directed to the microcomputer of the twenty-seventh embodiment, further comprising an interrupt control section which masks an interrupt request signal input to the CPU during a period when the operation of the CPU is stopped.

According to the twenty-eighth embodiment, the CPU cannot perform an interrupt operation during a period when the memory data of the memory is protected against fraudulent read attempts. However, absence of the interrupt process can be avoided because an interrupt request itself is masked to be left unaccepted.

The twenty-ninth embodiment of the present invention is directed to the microcomputer of the first embodiment, wherein the debug control section prevents data from being output from the microcomputer to the external debug instruction device during a period between connection of the external debug instruction device to the microcomputer that is in a normal operation and success of the authentication.

According to the twenty-ninth embodiment, data is not output from the microcomputer to the external debug instruction device during a period between connection of the external debug instruction device to the microcomputer and success of authentication.

### BRIEF DESCRIPTION OF THE DRAWINGS

FIG. 1 is a block diagram showing the structure of a microcomputer 100 according to embodiment 1.

FIG. 2 is a block diagram showing the structure of a microcomputer 200 according to embodiment 2.

FIG. 3 is a block diagram showing the structure of a microcomputer 300 according to embodiment 3.

FIG. 4 is a block diagram showing the structure of a microcomputer 400 according to embodiment 4.

FIG. 5 is a block diagram showing the structure of a microcomputer 500 according to embodiment 5.

FIG. 6 is a block diagram showing the structure of a microcomputer 600 according to embodiment 6.

FIG. 7 is a block diagram showing the structure of a microcomputer 700 according to embodiment 7.

FIG. 8 is a block diagram showing the structure of a microcomputer 800 according to embodiment 8.

### DESCRIPTION OF THE PREFERRED EMBODIMENTS

Hereinafter, embodiments of the present invention will be described with reference to the drawings. In the embodiments described below, elements having like functions are denoted by the same reference numerals, and the descriptions of these elements are not redundantly provided.

### Embodiment 1

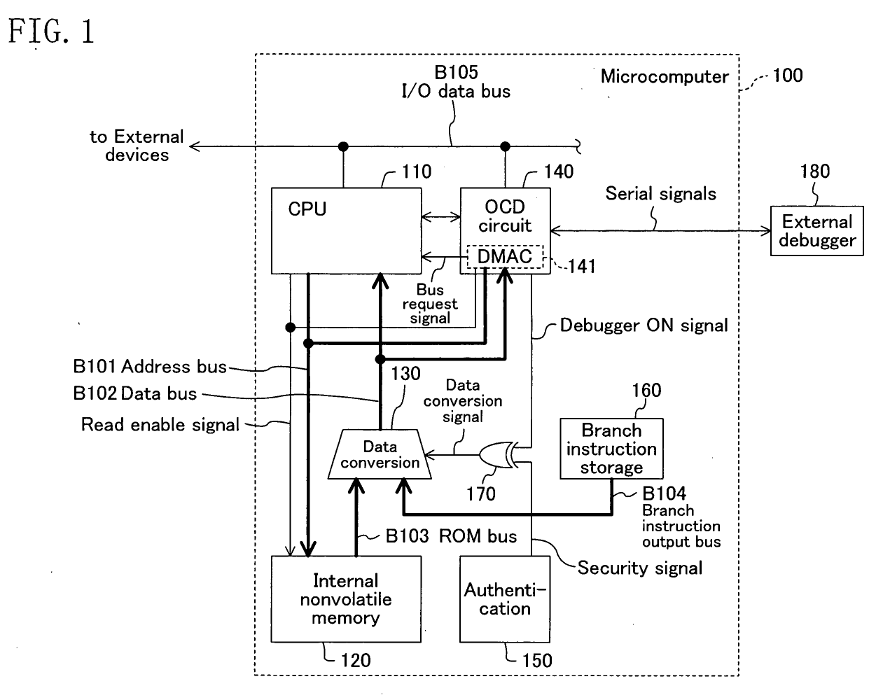

FIG. 1 is a block diagram showing the structure of a microcomputer 100 according to embodiment 1 of the present invention.

The microcomputer 100 includes a CPU (Central Processing Unit) 110, an internal nonvolatile memory 120 (memory), a data conversion section 130 (memory control section), an OCD (On Chip Debug) circuit 140 (debug control section), an authentication section 150, a branch instruction storage section 160, and an Exclusive OR circuit 170. At the time of debugging, the microcomputer 100 is connected to an external debugger 180 (external debug instruction device) provided outside the microcomputer 100.

The CPU 110 retrieves operation codes from the internal nonvolatile memory 120 and decodes the operation codes to execute the resultant instructions for implementing various control operations. Retrieval of an interested operation code is carried out such that the CPU 110 outputs to an address bus B101 an address of a region in which the operation code is stored, and a read enable signal is set to value “1”. The retrieved operation code is supplied to the CPU 110 through a ROM bus B103 and a data bus B102. Meanwhile, the CPU 110 receives a bus request signal from a DMAC 141. If the value of the bus request signal is set to “1”, the CPU 110 stops the operation.

The internal nonvolatile memory 120 stores operation codes and other data. If the read enable signal is value “1”, operation codes and other data stored in memory regions designated by addresses output to the address bus B101 are output to the ROM bus B103. The ROM bus B103 is connected only to the data conversion section 130.

If the value of a data conversion signal is “1”, the data conversion section 130 outputs the data of the ROM bus B103 to the data bus B102. If the value of the data conversion signal is “0”, the data conversion section 130 outputs the data of a branch instruction output bus B104 to the data bus B102.

The OCD circuit 140 is designed to output serial signals to the external debugger 180 and to receive serial signals from the external debugger 180. The OCD circuit 140 also monitors the internal conditions of the microcomputer 100 according to a signal received from the external debugger 180. Also, the OCD circuit 140 outputs a debugger ON signal. When the microcomputer 100 is not connected with the external debugger 180, the value of the debugger ON signal is “0”. When the microcomputer 100 is connected with the external debugger 180, the value of the debugger ON signal is “1”. The OCD circuit 140 includes the DMAC (Direct Memory Access Controller) 141 which is connected to the address bus B101 and the data bus B102.

The DMAC 141 is designed to output serial signals to the external debugger 180 and to receive serial signals from the external debugger 180. The DMAC 141 is controlled by the external debugger 180 in a predetermined manner to read data stored in the internal nonvolatile memory 120 without the intervention of the CPU 110 and convert the data to serial signals which are then output to the external debugger 180. When reading data from the internal nonvolatile memory 120 without the intervention of the CPU 110, the DMAC 141 is controlled by the external debugger 180 to set the value of the bus request signal to “1”, whereby the operation of the CPU 110 is stopped. After the operation of the CPU 110 is stopped, the DMAC 141 outputs, to the address bus B101, an address of the internal nonvolatile memory 120 storing an operation code which is to be read and meanwhile sets the read enable signal to value “1” in order to read data of the internal nonvolatile memory 120 through the data bus B102.

The authentication section 150 outputs a security signal. Until success of authentication, the authentication section 150 sets the security signal to the initial value, “1”, and after success of authentication, the authentication section 150 sets the security signal to value “0”. Initialization of various signals, such as the security signal, and the like, occurs, for example, when the microcomputer 100 is powered ON, or when the external debugger 180 is connected to the microcomputer 100. The authentication method carried out in the authentication section 150 is, for example, comparison between an authentication code stored in the authentication section in advance and an authentication code input from the debugger.

The branch instruction storage section 160 stores an operation code which is supposed to be decoded by the CPU 110 into an instruction for branching to a region where the relative address is 0 and outputs the operation code to the branch instruction output bus B104. Herein, the operation code which is supposed to be decoded into an instruction for branching to a region where the relative address is 0 is an operation code indicative of a branch instruction for branching to an address that the CPU 110 is currently accessing, for example, instruction “jr+0”.

The Exclusive OR circuit 170 outputs the exclusive logical sum (XOR) of two input signals as the data conversion signal. In this embodiment, the debugger ON signal and the security signal are input to the Exclusive OR circuit 170.

—Operation—

The instruction execution operation of the CPU 110 in the microcomputer 100 having the above-described structure is first described. This operation is common among the subsequent embodiments.

To retrieve an operation code from the internal nonvolatile memory 120, the CPU 110 outputs an address storing an operation code which is to be output to the address bus B101, for example, address “100H” (“H” denotes hexadecimal notation). Meanwhile, the CPU 110 sets the read enable signal to value “1”. Then, the CPU 110 retrieves an operation code from the data bus B102 and decodes the operation code to execute the resultant instruction.

Next, an operation of the DMAC 141 for reading data stored in the internal nonvolatile memory 120 is described. This operation is also common among the subsequent embodiments.

To read data from the internal nonvolatile memory 120, the DMAC 141 sets the value of the bus request signal to “1” and outputs to the address bus B101 an address storing an operation code which is to be read, for example, address “100H”. Further, the DMAC 141 sets the read enable signal to value “1”. Then, the DMAC 141 reads data through the data bus B102 and converts the data to serial signals which are then output to the external debugger 180.

Next, an operation of the microcomputer 100 is described wherein the CPU 110 starts an instruction execution operation while the external debugger 180 is not connected to the microcomputer 100, and the external debugger 180 is then connected to the microcomputer 100 in the midst of execution of the instruction, and thereafter, authentication is successfully done.

First, the operation of the microcomputer 100 which is carried out during execution of the instruction while the external debugger 180 is not connected to the microcomputer 100 is described.

In this period, authentication is not yet successfully completed in the authentication section 150, so that the authentication section 150 outputs “1” as the security signal. Since the external debugger 180 is not connected to the OCD circuit 140, the OCD circuit 140 outputs ”0” as the debugger ON signal. Since the security signal is “1” and the debugger ON signal is “0”, the data conversion signal, which is the output of the Exclusive OR circuit 170, is “1”. The data conversion section 130 outputs the data of the ROM bus B103 to the data bus B102. Therefore, the CPU 110 retrieves the data of the ROM bus B103, i.e., the data output from the internal nonvolatile memory 120. In the case where the retrieved data is an operation code, the CPU 110 decodes the operation code to execute the resultant instruction.

Next, the operation of the microcomputer 100 carried out during a period between connection of the external debugger 180 to the microcomputer 100 and success of authentication is described. Hereinafter, an instance where the CPU 110 is accessing address “100H” at the time when the external debugger 180 is connected to the microcomputer 100 is described.

In this period, authentication is not yet successfully completed in the authentication section 150, so that the authentication section 150 outputs “1” as the security signal. Since the external debugger 180 is connected to the OCD circuit 140, the OCD circuit 140 outputs “1” as the debugger ON signal. Since the security signal is “1” and the debugger ON signal is “1”, the data conversion signal, which is the output of the Exclusive OR circuit 170, is “0”. Therefore, the data conversion section 130 outputs the data of the branch instruction output bus B104 to the data bus B102. The data of the branch instruction output bus B104, i.e., the operation code stored in the branch instruction storage section 160, is retrieved and decoded by the CPU 110, and the resultant instruction is executed by the CPU 110.

Thus, when authentication is not yet successfully completed, the instruction of the operation code output from the internal nonvolatile memory 120 is not carried into execution. Therefore, an instruction to output data stored in the internal nonvolatile memory 120 to an I/O data bus B105, for example, instruction “mov mem reg, mov reg out”, is not carried into execution. Namely, the data stored in the internal nonvolatile memory 120 are protected against a fraudulent read attempt which would be carried out through execution of an instruction by the CPU 110.

Since the data output to the data bus B102 is not derived from the internal nonvolatile memory 120, the data output from the internal nonvolatile memory 120 is not read out by the DMAC 141. Therefore, the data of the internal nonvolatile memory 120 is prevented from being output to the external debugger 180 through the DMAC 141 until success of authentication.

In this process, the operation code stored in the branch instruction storage section 160 which is retrieved by the CPU 110 is an operation code which is supposed to be decoded by the CPU 110 into an instruction for branching to a region where the relative address is 0. Since when the external debugger 180 is connected to the microcomputer 100 the address that the CPU 110 is currently accessing, i.e., the value of the program counter, is “100H”, the CPU 110 executes an instruction equivalent to the branch instruction for branching to address 100H. Specifically, as the execution operation of the branch instruction, the CPU 110 outputs address “100H” to the address bus B101 and sets the read enable signal to value “1”. The CPU 110 repeats retrieval of operation codes stored in the branch instruction storage section 160 and execution of the branch instruction until success of authentication.

Next, the operation of the microcomputer 100 carried out after a predetermined authentication procedure ends in success of authentication is described.

After success of authentication, the authentication section 150 outputs “0” as the security signal. Since the OCD circuit 140 is still connected to the external debugger 180, the OCD circuit 140 outputs “1” as the debugger ON signal. Since the security signal is “0” and the debugger ON signal is “1”, the data conversion signal, which is the output of the Exclusive OR circuit 170, is “1”, so that the data conversion section 130 outputs the data of the ROM bus B103 to the data bus B102. Therefore, the CPU 110 decodes the data of the ROM bus B103, i.e., the operation code output from the internal nonvolatile memory 120, to execute the resultant instruction. Herein, the operation code output to the data bus B102 at the time of success of authentication is the data of the ROM bus B103. The data of the ROM bus B103 is an operation code stored in address 100H of the internal nonvolatile memory 120 because address “100H” is output to the address bus B101. Thus, after success of authentication, the CPU 110 starts sequentially retrieving and decoding operation codes from address 100H to execute the resultant instructions.

As described above, the microcomputer 100 is configured such that the branch instruction for branching to an address that the CPU 110 is currently accessing is repeatedly executed until success of authentication. With such a structure, even when the external debugger 180 is connected to the microcomputer 100 in the midst of execution of the instruction by the CPU 110, i.e., even when so-called hot insertion or removal occurs, debugging can be started at the time of success of authentication with the program counter value saved at the time of connection of the external debugger 180 to the microcomputer 100.

### Embodiment 2

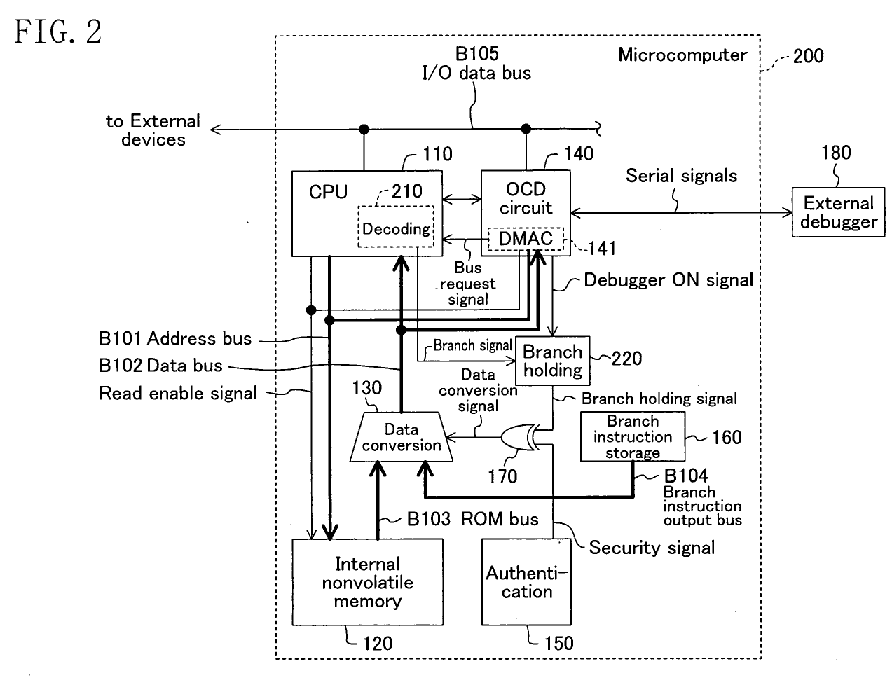

FIG. 2 is a block diagram showing the structure of a microcomputer 200 according to embodiment 2 of the present invention. Referring to FIG. 2, the microcomputer 200 includes a decoding section 210 and a branch holding section 220 in addition to the components of the microcomputer 100 of embodiment 1.

The decoding section 210 (branch instruction detection section) is incorporated inside the CPU 110 to decode an operation code retrieved by the CPU 110 from the data bus B102. If the operation code is a branch instruction, the decoding section 210 outputs “1” as a branch signal. If the operation code is not a branch instruction, the decoding section 210 outputs ”0” as the branch signal.

The branch holding section 220 (part of a memory control section) outputs a branch holding signal whose initial value is ”0”. When the branch signal is set to “1” while the debugger ON signal is “1”, the branch holding signal becomes “1”. Thereafter, the branch holding signal is kept at “1” until a next initialization.

—Operation—

Next, an operation of the microcomputer 200 is described wherein the CPU 110 starts execution of an instruction while the external debugger 180 is not connected to the microcomputer 200, and the external debugger 180 is then connected to the microcomputer 200 in the midst of execution of the instruction, and thereafter, authentication is successfully done.

First, the operation of the microcomputer 200 which is carried out during execution of an instruction while the external debugger 180 is not connected to the microcomputer 200 is described.

In this period, as in embodiment 1, the authentication section 150 outputs “1” as the security signal, and the OCD circuit 140 outputs ”0” as the debugger ON signal. Since the debugger ON signal is “0”, the branch holding section 220 outputs ”0” as the branch holding signal irrespective of the value of the branch signal. Since the security signal is “1” and the branch holding signal is “0”, the data conversion signal, which is the output of the Exclusive OR circuit 170, is “1”. The data conversion section 130 outputs the data of the ROM bus B103 to the data bus B102.

Next, the operation of the microcomputer 200 carried out during a period between connection of the external debugger 180 to the microcomputer 200 and success of authentication is described.

In this period, as in embodiment 1, the authentication section 150 outputs “1” as the security signal, and the OCD circuit 140 outputs “1” as the debugger ON signal. After the external debugger 180 is connected to the microcomputer 200, the branch signal is ”0” and the branch holding signal is ”0” till an operation code of a branch instruction is decoded for the first time. Therefore, the data conversion signal, which is the output of the Exclusive OR circuit 170, is “1”, so that the data conversion section 130 outputs the data of the ROM bus B103 to the data bus B102. When the operation code of the branch instruction is decoded by the decoding section 210, the branch signal is set to “1”, and the branch holding signal is set to “1”. Therefore, the data conversion signal, which is the output of the Exclusive OR circuit 170, is “0”, so that the data conversion section 130 outputs the data of the branch instruction output bus B104 to the data bus B102. For example, when after the external debugger 180 is connected to the microcomputer 200 the data output from the internal nonvolatile memory 120 to the CPU 110 is an operation code of the branch instruction for branching to address 200H, the decoding section 210 of the CPU 110 decodes the operation code and outputs “1” as the branch signal, while the CPU 110 executes the decoded branch instruction. At this point in time, the data of the branch instruction output bus B104, i.e., the operation code stored in the branch instruction storage section 160, is output to the data bus B102 because the branch signal has been set to “1”. Thus, even if the CPU 110 executes the branch instruction and outputs address “200H” to the address bus B101, the CPU 110 cannot retrieve the operation code of address 200H. The data retrieved by the CPU 110 is the data output from the branch instruction storage section 160, i.e., an operation code which is supposed to be decoded by the CPU 110 into an instruction for branching to a region where the relative address is 0. Since the branch holding signal is kept at “1” even after that, the data conversion section 130 continues to output the data of the branch instruction output bus B104 to the data bus B102. Therefore, the CPU 110 continues to execute the branch instruction for branching to address 200H until success of authentication. During this period, the data stored in the internal nonvolatile memory 120 are protected against external fraudulent read attempts. Namely, as described in embodiment 1, the data of the internal nonvolatile memory 120 are not fraudulently read out through execution of an instruction by the CPU 110 or fraudulently output to the external debugger 180 through the DMAC 141. Further, the protection against fraudulent read attempts is started after the operation code of the branch instruction is decoded. Therefore, disorder of a pipeline operation in the CPU 110 which would change the instruction execution timing can be avoided.

Next, the operation of the microcomputer 200 carried out after a predetermined authentication procedure ends in success of authentication is described.

After success of authentication, the authentication section 150 outputs ”0” as the security signal, while the branch holding signal is kept at “1”. Therefore, the data conversion signal, which is the output of the Exclusive OR circuit 170, is “1”, so that the data conversion section 130 outputs the data of the ROM bus B103 to the data bus B102. When the CPU 110 continues to execute the branch instruction for branching to address 200H until success of authentication as in the above-described instance, the CPU 110 starts, after success of authentication, sequentially retrieving and decoding operation codes from address 200H to execute the resultant instructions.

As described above, the microcomputer 200 is configured such that the branch instruction for branching to an address that the CPU 110 is currently accessing is repeatedly executed until success of authentication. With such a structure, even when the external debugger 180 is connected to the microcomputer 200 in the midst of execution of the instruction by the CPU 110, i.e., even when so-called hot insertion or removal occurs, debugging can be started at the time of success of authentication with the program counter value saved at the time of connection of the external debugger 180 to the microcomputer 200. Furthermore, after the external debugger 180 is connected and the branch instruction is decoded, the data output from the internal nonvolatile memory 120 is replaced by an operation code of an instruction for branching to a region where the relative address is 0. Therefore, after success of authentication, the branch instruction and subsequent instructions can be executed and debugging can be started with the pipeline state saved at the time of connection of the external debugger 180 to the microcomputer 200. More specifically, an instruction which is to be executed after success of authentication is fetched with the pipeline being flushed with the immediately previous branch instruction before execution as in the case where the external debugger 180 is not connected to the microcomputer 200. Namely, as for the execution timing of instructions, any difference in operation which would be caused according to connection/disconnection of the external debugger 180 can be avoided.

### Embodiment 3

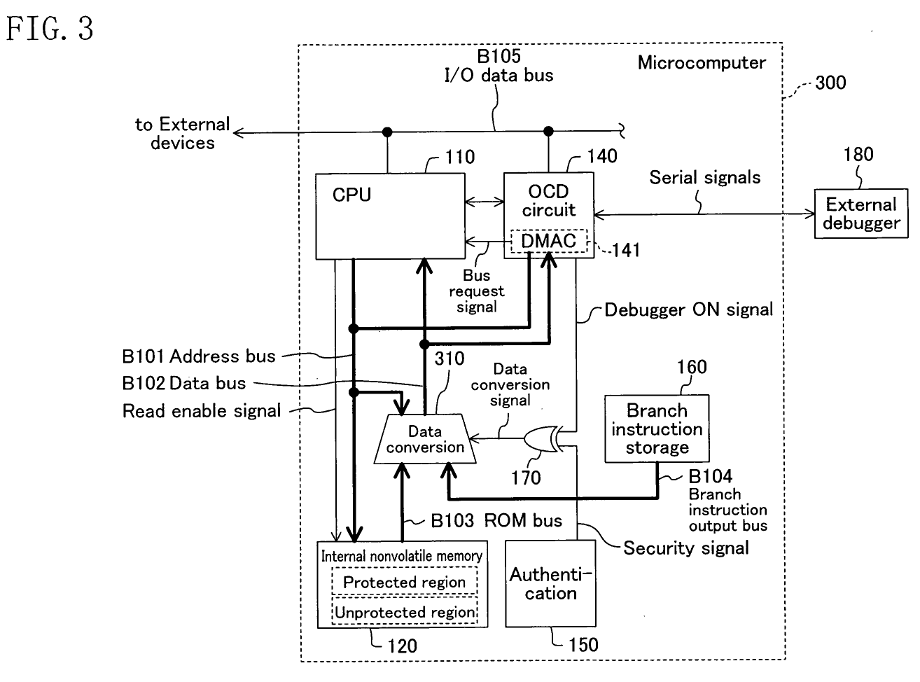

FIG. 3 is a block diagram showing the structure of a microcomputer 300 according to embodiment 3 of the present invention. As shown in FIG. 3, the microcomputer 300 includes a data conversion section 310 (memory control section and protected region access detection section) in place of the data conversion section 130 of the microcomputer 100 of embodiment 1. In the microcomputer 300, data stored in part of the internal nonvolatile memory 120 is externally readable even during a period between connection of the external debugger 180 to the microcomputer 300 and success of authentication. Hereinafter, the externally-readable part of the internal nonvolatile memory 120 is referred to as an unprotected region, and the other part is referred to as a protected region.

The data conversion section 310 is supplied not only with the data conversion signal but also with an address output to the address bus B101. If the value of the data conversion signal is “1”, the data conversion section 310 outputs the data of the ROM bus B103 to the data bus B102 as does the data conversion section 130 of the microcomputer 100. A difference of the data conversion section 310 from the data conversion section 130 is that, even when the value of the data conversion signal is “0”, the data conversion section 310 outputs the data of the ROM bus B103 to the data bus B102 so long as the address output to the address bus B101 is an address indicative of the unprotected region of the internal nonvolatile memory 120. In the case where the value of the data conversion signal is ”0” and the address output to the address bus B101 is an address indicative of the protected region of the internal nonvolatile memory 120, the data conversion section 310 outputs the data of the branch instruction output bus B104 to the data bus B102.

—Operation—

Next, an operation of the microcomputer 300 is described wherein the CPU 110 starts an instruction execution operation while the external debugger 180 is not connected to the microcomputer 300, and the external debugger 180 is then connected to the microcomputer 300 in the midst of execution of the instruction, and thereafter, authentication is successfully done.

The instruction execution operation which is carried out while the external debugger 180 is not connected to the microcomputer 300 and the operation carried out after success of authentication are the same as those described in embodiment 1, and therefore, the descriptions of these operations are herein omitted.

Hereinafter, the operation of the microcomputer 300 carried out during a period between connection of the external debugger 180 to the microcomputer 300 and success of authentication is described. The description herein is given with an instance where the external debugger 180 is connected to the microcomputer 300 while the CPU 110 is accessing address 100H of the internal nonvolatile memory 120.

After the external debugger 180 is connected to the microcomputer 300, the data conversion signal is “0” until success of authentication as in embodiment 1. When the external debugger 180 is connected to the microcomputer 300, the CPU 110 outputs address “100H” to the address bus B101 and sets the read enable signal to value “1” in order to retrieve the operation code of address 100H.

When the address output to the address bus B101, i.e., address 100H of the internal nonvolatile memory 120, is within the unprotected region, the data conversion section 310 outputs the data of the ROM bus B103 to the data bus B102. The operation code of address 100H is retrieved and decoded by the CPU 110, and the resultant instruction is executed by the CPU 110. The data conversion section 310 continues to output the data of the ROM bus B103 to the data bus B102 so long as a region of the internal nonvolatile memory 120 that the CPU 110 accesses is not a protected region. Therefore, the CPU 110 continues to execute the instruction of the operation code of the internal nonvolatile memory 120.

When the address output to the address bus B101, i.e., address 100H of the internal nonvolatile memory 120, is within the protected region, the data conversion section 310 outputs the data of the branch instruction output bus B104 to the data bus B102. Since the data of the branch instruction output bus B104 is an operation code of a branch instruction to an address that the CPU 110 is currently accessing, which is output from the branch instruction storage section 160, an instruction equivalent to the branch instruction for branching to address 100H is executed. Thus, the data stored in address 100H of the nonvolatile memory 120 is not read out by the CPU 110. The CPU 110 again outputs address “100H” to the address bus B101 and sets the read enable signal to value “1”. Therefore, an instruction equivalent to the branch instruction for branching to address 100H is repeatedly executed until success of authentication. Thus, before success of authentication, the data stored in the protected region of the internal nonvolatile memory 120 are not fraudulently read out through execution of an instruction by the CPU 110 or fraudulently output to the external debugger 180 through the DMAC 141. Namely, data which needs to be protected against fraudulent read attempts is provided with confidentiality so long as it is stored in the protected region of the internal nonvolatile memory 120.

As described above, the microcomputer 300 is configured such that whether data of the internal nonvolatile memory 120 is output to the data bus B102 depends on the address of the data. With such a structure, data which needs to be protected is protected against fraudulent read attempts, and an operation code which needs no protection can be executed by the CPU 110 even during a period between connection of the external debugger 180 to the microcomputer 300 and success of authentication. For example, an operation code of a process which needs to be promptly executed in whatever situation, such as an interrupt process, and the like, may be stored in an unprotected region.

### Embodiment 4

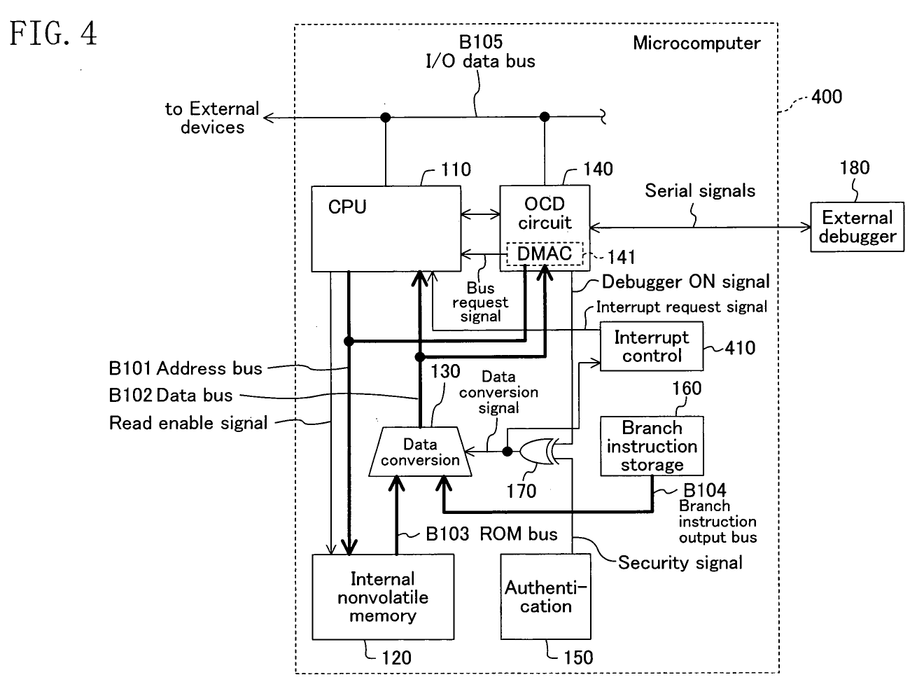

FIG. 4 is a block diagram showing the structure of a microcomputer 400 according to embodiment 4 of the present invention. As shown in FIG. 4, the microcomputer 400 includes an interrupt control section 410 in addition to the components of the microcomputer 100 of embodiment 1.

The interrupt control section 410 is configured such that, when receiving an interrupt request from another circuit (not shown), the interrupt control section 410 outputs “1” as an interrupt request signal to the CPU 110 and, when otherwise, the interrupt control section 410 outputs ”0” as the interrupt request signal to the CPU 110. When a multiple types of interrupt requests occur, the interrupt control section 410 arbitrates these requests. When the debugger ON signal is “1” and the security signal is “1”, the interrupt control section 410 sets the interrupt request signal to ”0” to prohibit an interrupt process in the CPU 110 irrespective of whether an interrupt request is given. In this embodiment, as shown in FIG. 4, the data conversion signal is input to the interrupt control section 410 as a signal indicative of whether the debugger ON signal is “1” and the security signal is “1”. When the data conversion signal is “0”, the interrupt control section 410 sets the interrupt request signal to ”0” irrespective of whether an interrupt request is given. When the data conversion signal is “1”, the interrupt control section 410 sets the interrupt request signal to “1” in response to an interrupt request.

When the interrupt request signal input to the CPU 110 is set to “1”, the CPU 110 pushes the current program counter value to a stack and outputs to the address bus B101 the leading address of a region in which the operation code of the interrupt process is stored to start retrieval of the operation code of the interrupt process. When the interrupt request signal input to the CPU 110 is set to “1”, the CPU 110 also outputs a signal indicative of acceptance of an interrupt.

—Operation—

In this embodiment, the principal operations, including switching of the operation code output to the data bus B102, etc., and the effects thereof are the same as those of embodiment 1, and therefore, the descriptions thereof are herein omitted. Herein, the operations relevant to the interrupt control section 410 are described. Hereinafter, part of the operation of the microcomputer 400 under the control of the interrupt control section 410 is mainly described wherein the CPU 110 starts execution of an instruction while the external debugger 180 is not connected to the microcomputer 400, and the external debugger 180 is then connected to the microcomputer 400 in the midst of execution of the instruction, and thereafter, authentication is successfully done.

First, the operation of the microcomputer 400 which is carried out during execution of the instruction while the external debugger 180 is not connected to the microcomputer 400 is described. In this period, the data conversion signal is “1” as in the instance described in embodiment 1. Since the data conversion signal is “1”, the interrupt control section 410 outputs “1” as the interrupt request signal to the CPU 110 in response to an interrupt request. Accordingly, the CPU 110 pushes the current program counter value to a stack and outputs to the address bus B101 the address in which the operation code of the interrupt process is stored to start retrieval of the operation code of the interrupt process. Thus, till the external debugger 180 is connected to the microcomputer 400, the CPU 110 executes an instruction of the interrupt process under the control of the interrupt control section 410 as soon as an interrupt request occurs.

Hereinafter, the operation of the microcomputer 400 carried out during a period between connection of the external debugger 180 to the microcomputer 400 and success of authentication is described. In this period, the data conversion signal is ”0”. Since the data conversion signal is “0”, the interrupt control section 410 outputs ”0” as the interrupt request signal even if an interrupt request is given. As a result, an interrupt process is not carried out in the CPU 110. Meanwhile, the data of the branch instruction storage section 160 is output to the data bus B102. Therefore, the CPU 110 retrieves the data of the branch instruction storage section 160, i.e., an operation code which is supposed to be decoded by the CPU 110 into an instruction for branching to a region where the relative address is 0, without shifting to the operation of retrieving the operation code of the interrupt process. Since the interrupt request signal is not “1” during the period between connection of the external debugger 180 to the microcomputer 400 and success of authentication, the signal from the CPU 110 indicative of acceptance of the interrupt is not output to an external device. Therefore, absence of an interrupt process which would occur contrary to the signal from the CPU indicative of acceptance of the interrupt can be avoided. Further, until success of authentication, the data stored in the internal nonvolatile memory 120 are protected against external read attempts as in embodiment 1.

Next, the operation of the microcomputer 400 carried out after a predetermined authentication procedure ends in success of authentication is described. After success of authentication, the data conversion signal is set to “1”. Since the data conversion signal is “1”, the interrupt control section 410 outputs “1” as the interrupt request signal to the CPU 110 in response to occurrence of an interrupt. Accordingly, the CPU 110 pushes the current program counter value to a stack and outputs to the address bus B101 the address in which the operation code of the interrupt process is stored to start retrieval of the operation code of the interrupt process. In this way, after success of authentication, the CPU 110 executes an instruction of the interrupt process under the control of the interrupt control section 410 as soon as an interrupt occurs.

### Embodiment 5

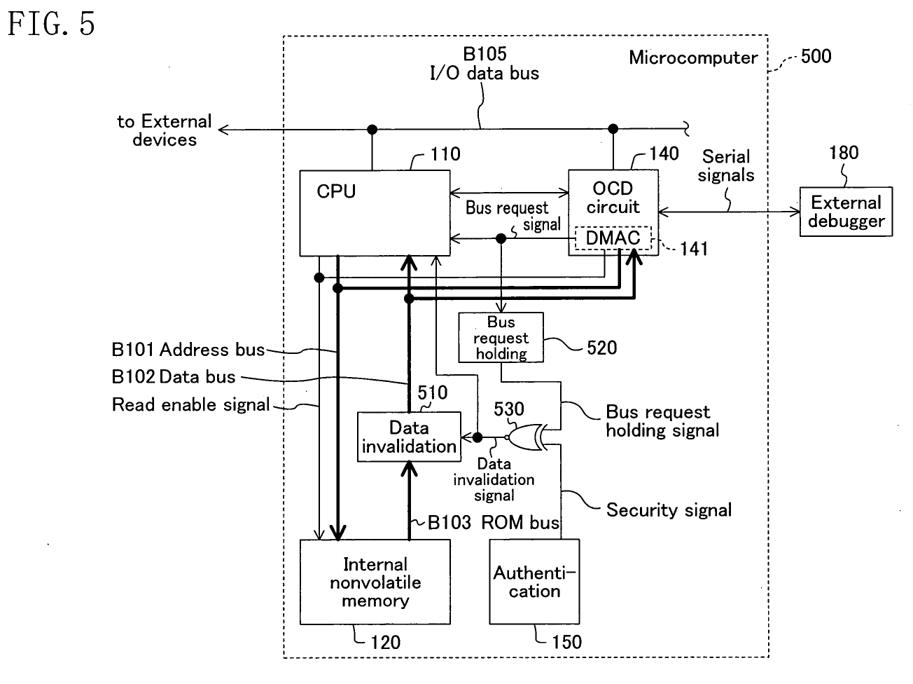

FIG. 5 is a block diagram showing the structure of a microcomputer 500 according to embodiment 5 of the present invention. As shown in FIG. 5, the microcomputer 500 is different from the microcomputer 100 of embodiment 1 in that the microcomputer 500 includes a data invalidation section 510 (memory control section) in substitution for the data conversion section 130, that the microcomputer 500 does not include the branch instruction storage section 160, and that the microcomputer 500 includes a bus request holding section 520. Further, the microcomputer 500 includes an Exclusive NOR circuit 530 in place of the Exclusive OR circuit 170. The Exclusive NOR circuit 530 inverts the exclusive logical sum of a bus request holding signal and the security signal, which are input to the Exclusive NOR circuit 530, and outputs the inverse as a data invalidation signal.

If the value of the data invalidation signal is “0”, the data invalidation section 510 outputs the data of the ROM bus B103 to the data bus B102. If the value of the data invalidation signal is “1”, the data invalidation section 510 outputs an operation code which is supposed to be decoded by the CPU 110 into an instruction indicative that nothing is to be executed.

In the initial state, the bus request holding section 520 outputs ”0” as the bus request holding signal. When the bus request signal is set to “1”, the bus request holding section 520 holds the value of “1” as the bus request holding signal and continues to output “1” until the next initialization.

If the data invalidation signal input to the CPU 110 is “1”, the CPU 110 stops all the operations.

—Operation—

Next, an operation of the microcomputer 500 is described wherein the CPU 110 starts execution of an instruction while the external debugger 180 is not connected to the microcomputer 500, and the external debugger 180 is then connected to the microcomputer 500 in the midst of execution of the instruction, and thereafter, authentication is successfully done.

First, the operation of the microcomputer 500 which is carried out during execution of the instruction while the external debugger 180 is not connected to the microcomputer 500 is described.

In this period, the authentication section 150 outputs “1” as the security signal. The DMAC 141 outputs ”0” as the bus request signal because the external debugger 180 is not connected to the microcomputer 500. Therefore, the bus request holding section 520 continues to output the initial value, “0”, as the bus request holding signal. Since the security signal is “1” and the bus request holding signal is “0”, the data invalidation signal, which is the output of the Exclusive NOR circuit 530, is “0”, so that the data invalidation section 510 outputs the data of the ROM bus B103 to the data bus B102. Therefore, the CPU 110 decodes the data of the ROM bus B103, i.e., the operation code output from the internal nonvolatile memory 120, to execute the resultant instruction.

Next, the operation of the microcomputer 500 carried out during a period between connection of the external debugger 180 to the microcomputer 500 and transition of the value of the bus request signal by the DMAC 141 from ”0” to “1” is described. In this period, the authentication section 150 continues to output value “1” as the security signal, and the DMAC 141 outputs ”0” as the bus request signal. Therefore, the bus request holding section 520 continues to output the initial value, “0”, as the bus request holding signal. Since the security signal is “1” and the value of the bus request holding signal is “0”, the value of the data invalidation signal, which is the output of the Exclusive NOR circuit 530, is ”0”. Accordingly, the data invalidation section 510 outputs the data of the ROM bus B103 to the data bus B102. Thus, even when the external debugger 180 is connected to the microcomputer 500, the CPU 110 decodes the data of the ROM bus B103, i.e., the operation code output from the internal nonvolatile memory 120, to execute the resultant instruction so long as the DMAC 141 continues to output ”0” as the value of the bus request signal.

Next, the operation of the microcomputer 500 carried out during a period between an attempt by the DMAC 141 to read data of the internal nonvolatile memory 120 through DMA (direct memory access) under the control of the external debugger 180 and success of authentication is described. Hereinafter, the description is given with an instance where, at the start of DMA (when the value of the bus request signal becomes “1”), an address that the CPU 110 is currently accessing, i.e., the value of the program counter, is “100H”.

When the value of the bus request signal becomes “1”, the bus request holding section 520 holds and continues to output the value of “1”. Meanwhile, the security signal is still “1” because authentication is not yet successfully completed. Accordingly, the value of the data invalidation signal, which is the output of the Exclusive NOR circuit 530, is “1” so that the CPU 110 stops the operations, and the data invalidation section 510 outputs to the data bus B102 an invalid operation code which is supposed to be decoded by the CPU 110 into an instruction indicative that nothing is to be executed. Thus, even when the DMAC 141 outputs any address to the address bus B101 and sets the read signal to “1”, what is actually output from the data invalidation section 510 is an invalid operation code. Namely, since the data of the internal nonvolatile memory 120 is not output to the data bus B102 before success of authentication, the data of the internal nonvolatile memory 120 is prevented from being fraudulently read out through execution of an instruction by the CPU 110 or being fraudulently read out from the external debugger 180 through the DMAC 141. After the external debugger 180 is connected to the microcomputer 500, the CPU 110 does not stop before the DMAC 141 outputs the bus request signal. Therefore, even when the necessity of executing a process of high urgency occurs in this period, the process can be executed, so that deterioration in realtimeness can be suppressed.

The operation of the microcomputer 500 carried out after a predetermined authentication procedure ends in success of authentication is now described.

After success of authentication, the authentication section 150 outputs ”0” as the security signal. The bus request holding section 520 continues to output the value of “1”. Therefore, the value of the data invalidation signal, which is the output of the Exclusive NOR circuit 530, is “0”, so that the data invalidation section 510 outputs the data of the ROM bus B103 to the data bus B102.

Since the data of the ROM bus B103 is output to the data bus B102, it is possible to read out the data of the internal nonvolatile memory 120 from the external debugger 180 through the DMAC 141.

Meanwhile, the data invalidation signal becomes ”0” so that the CPU 110 starts operations again. Since the address that the CPU 110 is accessing at the time of the stop of the operation is “100H”, retrieval, decoding, and execution of instructions are started with the operation code stored in address 100H. With such a structure that the CPU 110 stops the operations until success of authentication, even when the external debugger 180 is connected to the microcomputer 500 in the midst of execution of the instruction by the CPU 110, i.e., even when so-called hot insertion or removal occurs, debugging can be started at the time of success of authentication with the program counter value saved at the time of connection of the external debugger 180 to the microcomputer 500.

Since the bus request holding section 520 continues to output the value of “1” even after the value of the bus request signal becomes “0”, the value of the data invalidation signal is maintained at “0”, so that the data invalidation section 510 outputs the data of the ROM bus B103 to the data bus B102. Thus, once the authentication has been successfully done, both externally reading the data of the internal nonvolatile memory 120 through execution of an instruction by the CPU 110 and reading the data of the internal nonvolatile memory 120 from the external debugger 180 through the DMAC 141 are possible.

### Embodiment 6

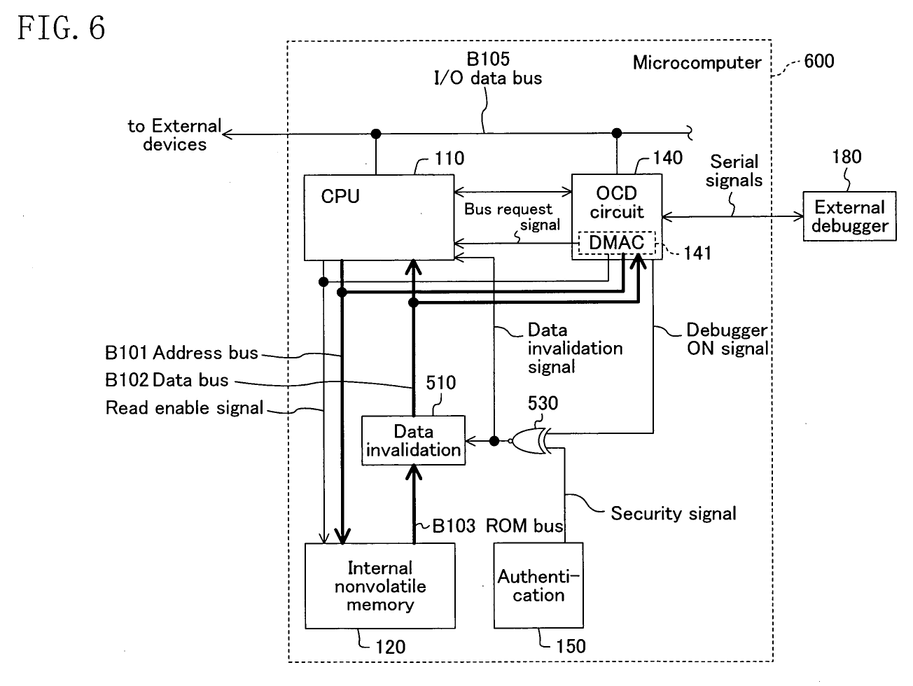

FIG. 6 is a block diagram showing the structure of a microcomputer 600 according to embodiment 6 of the present invention. As shown in FIG. 6, the microcomputer 600 is different from the microcomputer 100 of embodiment 1 in that the microcomputer 600 includes the data invalidation section 510 (memory control section) in substitution for the data conversion section 130, and that the microcomputer 600 does not include the branch instruction storage section 160.

The data invalidation signal, which is the output of the Exclusive NOR circuit 530, is input to the CPU 110 of this embodiment. If the value of the data invalidation signal is “1”, the CPU 110 stops all the operations.

—Operation—

Next, an operation of the microcomputer 600 is described wherein the CPU 110 starts execution of an instruction while the external debugger 180 is not connected to the microcomputer 600, and the external debugger 180 is then connected to the microcomputer 600 in the midst of execution of the instruction, and thereafter, authentication is successfully done.

First, the operation of the microcomputer 600 during execution of the instruction which is carried out while the external debugger 180 is not connected to the microcomputer 600 is described.

In this period, the data invalidation signal, which is the output of the Exclusive NOR circuit 530, is ”0” as in the example described in embodiment 5. Since the data invalidation signal is “0”, the data invalidation section 510 outputs the data of the ROM bus B103 to the data bus B102. Therefore, the CPU 110 continues retrieval, decoding, and execution of the instruction of the operation code of the data of the ROM bus B103 output to the data bus B102, i.e., the operation code output from the internal nonvolatile memory 120, without stopping the operations.

Next, the operation of the microcomputer 600 carried out during a period between connection of the external debugger 180 to the microcomputer 600 and success of authentication is described. Hereinafter, an instance where the CPU 110 is accessing address “100H” at the time when the external debugger 180 is connected to the microcomputer 600 is described.

After the external debugger 180 is connected to the microcomputer 600, the data invalidation signal is “1” until success of authentication as in the example described in embodiment 5. Since the data invalidation signal is “1”, the data invalidation section 510 outputs an operation code which is supposed to be decoded by the CPU 110 into an instruction indicative that nothing is to be executed. As a result, the data of the internal nonvolatile memory 120 is not output to the data bus B102 before success of authentication. Therefore, the data of the internal nonvolatile memory 120 is prevented from being fraudulently read out. Namely, as described in embodiment 1, the data of the internal nonvolatile memory 120 are not fraudulently output to the external debugger 180 through the DMAC 141. Meanwhile, since the data invalidation signal is “1”, the CPU 110 stops all the operations.

The operation of the microcomputer 600 carried out after a predetermined authentication procedure ends in success of authentication is now described.

After success of authentication, the data invalidation signal becomes “0”. Since the data invalidation signal is “0”, the data invalidation section 510 outputs the data of the ROM bus B103 to the data bus B102. Meanwhile, since the data invalidation signal is “0”, the CPU 110 starts operations. The address that the CPU 110 is accessing at the time when the operations of the CPU 110 stop, i.e., at the time when the external debugger 180 is connected to the microcomputer 600, is “100H”, retrieval, decoding, and execution of instructions are started with the operation code stored in address 100H.

Thus, once the authentication has been successfully done, the data of the internal nonvolatile memory 120 can be externally read out through execution of an instruction by the CPU 110. Also, the data of the internal nonvolatile memory 120 can be read out from the external debugger 180 through the DMAC 141.

With such a structure that the CPU 110 stops the operations until success of authentication, even when the external debugger 180 is connected to the microcomputer 600 in the midst of execution of the instruction by the CPU 110, i.e., even when so-called hot insertion or removal occurs, the CPU 110 starts operations to start debugging, at the time of success of authentication, with the program counter value and pipeline state saved at the time of connection of the external debugger 180 to the microcomputer 600.

It should be noted that, although in this embodiment the CPU 110 stops all the operations when the data invalidation signal is “1”, all of the operations may not necessarily be stopped so long as the operation of updating the program counter value is stopped.

### Embodiment 7

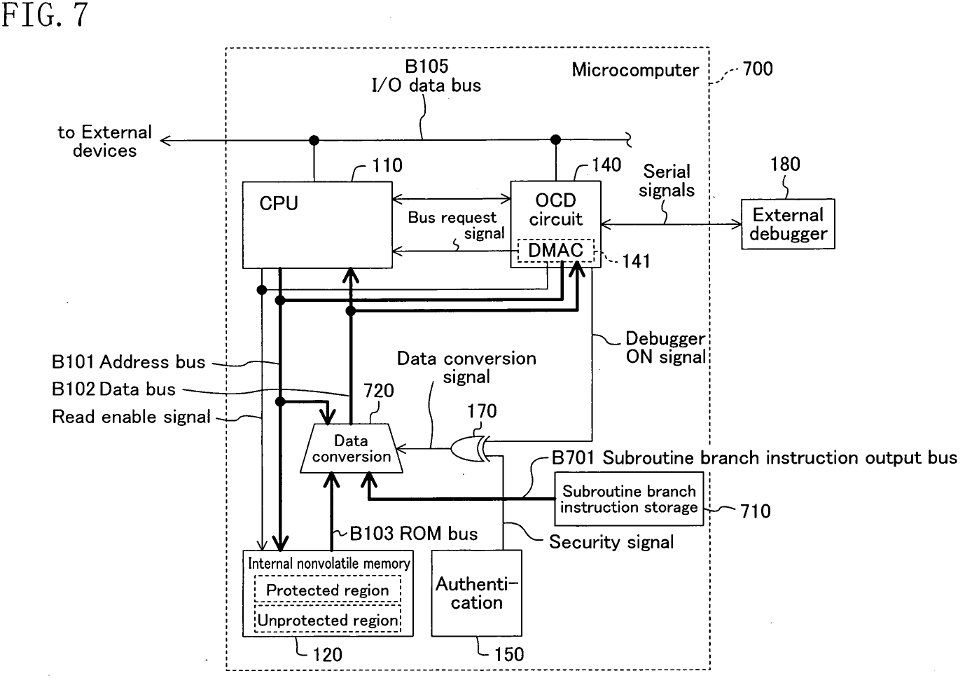

FIG. 7 is a block diagram showing the structure of a microcomputer 700 according to embodiment 7 of the present invention. As shown in FIG. 7, the microcomputer 700 is different from the microcomputer 100 of embodiment 1 in that the microcomputer 700 includes a subroutine branch instruction storage section 710 in place of the branch instruction storage section 160. Further, the microcomputer 700 includes a data conversion section 720 (memory control section and protected region access detection section) in place of the data conversion section 130 of embodiment 1. The data conversion section 720 outputs data stored in part of the internal nonvolatile memory 120 (unprotected region) to the data bus B102 even during a period between connection of the external debugger 180 to the microcomputer 700 and success of authentication. The unprotected region stores the operation code of the return instruction for returning to the program counter a return address which has been pushed to the stack.

The subroutine branch instruction storage section 710 stores an operation code which is supposed to be decoded by the CPU 110 into an instruction for branching to, for example, the leading address of the unprotected region of the internal nonvolatile memory 120, and outputs the operation code to a subroutine branch instruction output bus B701.

The unprotected region of the internal nonvolatile memory 120 stores an operation code of a subroutine which starts with an instruction of a branch target address of the branch instruction stored in the subroutine branch instruction storage section 710 and which ends with a return instruction for returning the return address which has been pushed to the stack.

When the value of the data conversion signal is “1”, the data conversion section 720 outputs the data of the ROM bus B103 to the data bus B102. When the value of the data conversion signal is “0”, the data conversion section 720 outputs the data of the subroutine branch instruction output bus B701 to the data bus B102 in the first read cycle of the CPU 110. In the second and subsequent cycles after the data conversion signal becomes “0”, if the address output to the address bus B101 is an address indicative of the unprotected region of the internal nonvolatile memory 120, the data conversion section 720 outputs the data of the ROM bus B103 to the data bus B102, and if the address output to the address bus B101 is an address indicative of the protected region of the internal nonvolatile memory 120, the data conversion section 720 outputs to the data bus B102 data equivalent to an operation code which is supposed to be decoded by the CPU 110 into an instruction indicative that nothing is to be executed.

When the CPU 110 retrieves from the data bus B102 an operation code of an instruction for branching to a subroutine and decodes the operation code, the CPU 110 stores a currently accessed address (program counter value), i.e., the CPU 110 pushes a currently accessed address to the stack, and outputs the branch target address of the instruction to the address bus B101. Meanwhile, the CPU 110 sets the read enable signal to value “1”. When the CPU 110 retrieves from the data bus B102 an operation code of an instruction for returning the return address which has been pushed to the stack to the program counter and decodes the operation code, the CPU 110 returns the return address which has been pushed to the stack to the program counter and outputs the address to the address bus B101. Meanwhile, the CPU 110 sets the read enable signal to value “1”.

—Operation—

Next, an operation of the microcomputer 700 is described wherein the CPU 110 starts execution of an instruction while the external debugger 180 is not connected to the microcomputer 700, and the external debugger 180 is then connected to the microcomputer 700 in the midst of execution of the instruction, and thereafter, authentication is successfully done.

First, the operation of the microcomputer 700 during execution of the instruction which is carried out while the external debugger 180 is not connected to the microcomputer 700 is described. In this period, the data conversion signal, which is the output of the Exclusive OR circuit 170, is “1” as in embodiment 1. Since the data conversion signal is “1”, the data conversion section 720 outputs the data of the ROM bus B103 to the data bus B102. Therefore, the CPU 110 retrieves and decodes an operation code of the data of the ROM bus B103 which has been output to the data bus B102, i.e., an operation code output from the internal nonvolatile memory 120, to execute the resultant instruction.

Next, the operation of the microcomputer 700 carried out during a period between connection of the external debugger 180 to the microcomputer 700 and success of authentication is described. Hereinafter, an instance where the CPU 110 is accessing address “100H” at the time when the external debugger 180 is connected to the microcomputer 700 is described.

After the external debugger 180 is connected to the microcomputer 700, the data conversion signal is ”0” until success of authentication. Therefore, in the first read cycle of the CPU 110 after the data conversion signal becomes “0”, the data conversion section 720 outputs to the data bus B102 the data of the subroutine branch instruction output bus B701, i.e., the operation code which is supposed to be decoded by the CPU 110 into an instruction for branching to the leading address of the unprotected region of the internal nonvolatile memory 120. Therefore, the CPU 110 retrieves from the data bus B102 the operation code of the instruction for branching to the leading address of the unprotected region and decodes the operation code. The CPU 110 stores the currently accessed address, “100H” (i.e., pushes the currently accessed address to the stack), and outputs the leading address of the unprotected region to the address bus B101. Meanwhile, the CPU 110 sets the value of the read enable signal to “1”. In the second cycle after the data conversion signal becomes “0”, the address output to the address bus B101 is an address of the unprotected region. Accordingly, the data conversion section 720 outputs the operation code of the ROM bus B103 to the data bus B102. Therefore, the CPU 110 retrieves from the data bus B102 an operation code stored in the leading address of the unprotected region and decodes the operation code to execute the resultant instruction. Thereafter, so long as the address output to the address bus B101 is an address of the unprotected region, the operation code of the data of the ROM bus B103, i.e., the operation code output from the unprotected region of the internal nonvolatile memory 120, is retrieved from the data bus B102 and decoded by the CPU 110, and the resultant instruction is executed by the CPU 110.

Now, the operation of the microcomputer 700 is described wherein, when the operation code retrieved by the CPU 110 is an operation code of an instruction for reading predetermined data from the protected region, the data of the protected region are protected from being read out.

The CPU 110 retrieves from the unprotected region an operation code of an instruction for reading data stored in the protected region and decodes the operation code to output to the address bus B101 an address storing data which is to be read and set the read enable signal to “1”. Meanwhile, the data conversion section 720 outputs to the data bus B102 data equivalent to an operation code which is supposed to be decoded by the CPU 110 into an instruction indicative that nothing is to be executed because the operation is in the second or subsequent cycle after the data conversion signal becomes ”0” and the address output to the address bus B101 is an address of the protected region.

Now, the operation of the microcomputer 700 is described wherein, when the operation code retrieved by the CPU 110 is an operation code of an instruction for branching to a predetermined address of the protected region, the operation code of the protected region is protected from being read out.

The CPU 110 retrieves from the unprotected region an operation code of an instruction for branching to a predetermined address of the protected region and decodes the operation code to output a branch target address to the address bus B101 and set the read enable signal to “1”. Meanwhile, the data conversion section 720 outputs to the data bus B102 the operation code which is supposed to be decoded by the CPU 110 into an instruction indicative that nothing is to be executed because the operation is in the second or subsequent cycle after the data conversion signal becomes “0” and the address output to the address bus B101 is an address of the protected region. The CPU 110 retrieves the operation code from the data bus B102 and decodes the operation code to execute nothing.

Since the data of the protected region is not output to the data bus B102 during the period between connection of the external debugger 180 to the microcomputer 700 and success of authentication, the data of the protected region are not fraudulently read out from the external debugger 180 through the DMAC 141 or externally read out through execution of an instruction by the CPU 110.

Next, the operation of the microcomputer 700 carried out after a predetermined authentication procedure ends in success of authentication is described.

After success of authentication, the data conversion signal is “1”. Since the data conversion signal is “1”, the data conversion section 720 outputs the data of the ROM bus B103 to the data bus B102. Therefore, after success of authentication, it is possible to read out the data of the protected region from the internal nonvolatile memory 120.

Now, the operation of the microcomputer 700 is described wherein, after success of authentication, the CPU 110 resumes an access to address “100H” that the CPU 110 has been accessing at the time of connection of the external debugger 180 to the microcomputer 700. During the period between connection of the external debugger 180 to the microcomputer 700 and success of authentication, the operation code output from the unprotected region is retrieved and decoded by the CPU 110, and the resultant instruction is executed by the CPU 110. The CPU 110 retrieves from the unprotected region the operation code of a return instruction for returning the return address which has been pushed to the stack to the program counter and decodes the operation code to output address “100H”, which has been stored at the time of connection of the external debugger 180 to the microcomputer 700, to the address bus B101 and set the value of the read enable signal to “1”. Since the operation code of the return instruction for returning the return address which has been pushed to the stack to the program counter is stored in the unprotected region, the CPU 110 can resume after success of authentication retrieval of the operation code of address “100H”, which is the address that the CPU 110 has been accessing at the time of connection of the external debugger 180 to the microcomputer 700, by executing the return instruction. Therefore, even when the external debugger 180 is connected to the microcomputer 700 in the midst of execution of the instruction by the CPU 110 as described above, i.e., even when so-called hot insertion or removal occurs, the CPU 110 can start debugging after success of authentication with the program counter value saved at the time of connection of the external debugger 180 to the microcomputer 700.

As described above, in this embodiment, the microcomputer 700 is configured such that whether data of the internal nonvolatile memory 120 is output to the data bus B102 depends on the address of the data as in embodiment 3. Therefore, with such a structure, even during a period between connection of the external debugger 180 to the microcomputer 700 and success of authentication, the CPU 110 is enabled to execute an operation code which needs no protection without the microcomputer 700 going haywire, while data which needs protection is protected against fraudulent read attempts. For example, an operation code of a process which needs to be promptly executed in whatever situation, such as an interrupt process, and the like, may be stored in an unprotected region.

This embodiment utilizes such a mechanism common to the general CPUs that, when the CPU 110 executes a branch instruction, an address that the CPU 110 is currently accessing is pushed to a stack, and the address is returned from the stack to the program counter at the time of execution of the return instruction. Therefore, it is not necessary to provide an additional circuit, and advantageously, the circuit area does not increase.

### Embodiment 8

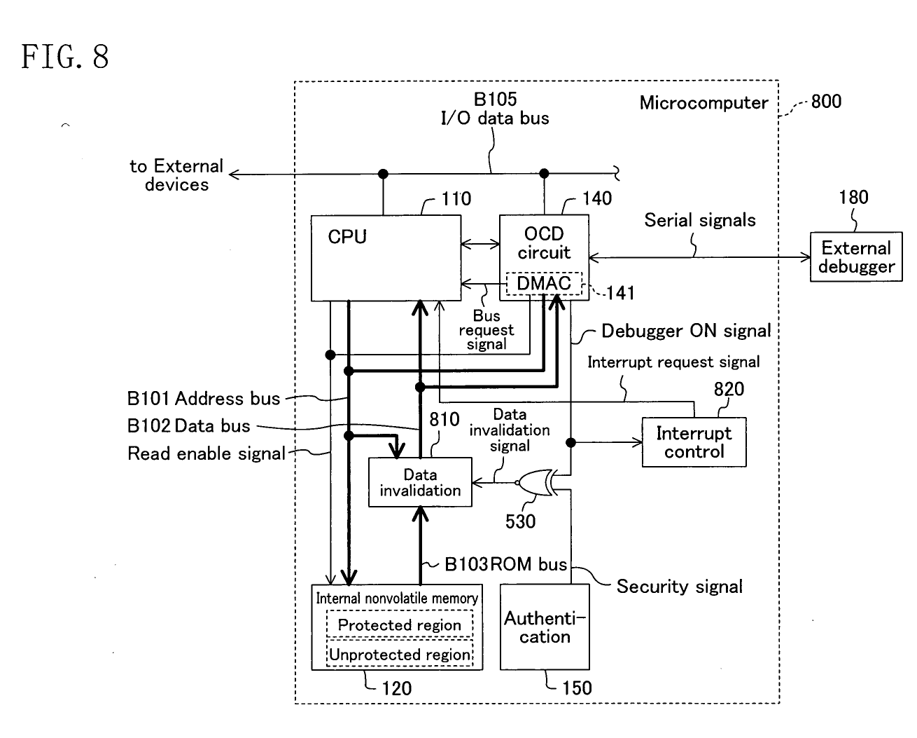

FIG. 8 is a block diagram showing the structure of a microcomputer 800 according to embodiment 8 of the present invention. As shown in FIG. 8, the microcomputer 800 is different from the microcomputer 100 of embodiment 1 in that the microcomputer 800 includes a data invalidation section 810 (memory control section and protected region access detection section) in substitution for the data conversion section 130, that the microcomputer 800 does not include the branch instruction storage section 160, and that the microcomputer 800 further includes an interrupt control section 820.

The data invalidation section 810 outputs data stored in part of the internal nonvolatile memory 120 (unprotected region) to the data bus B102 even during the period between connection of the external debugger 180 to the microcomputer 800 and success of authentication. If the value of the data invalidation signal is “0”, the data invalidation section 810 outputs the data of the ROM bus B103 to the data bus B102. If the value of the data invalidation signal is “1” and the address output to the address bus B101 is an address indicative of an unprotected region, the data invalidation section 810 outputs the data of the ROM bus B103 to the data bus B102. If the value of the data invalidation signal is “1” and the address output to the address bus B101 is an address indicative of a protected region, the data invalidation section 810 outputs to the data bus B102 an operation code which is supposed to be decoded by the CPU 110 into an instruction indicative that nothing is to be executed.

When receiving an interrupt request, the interrupt control section 820 outputs “1” as the interrupt request signal. When otherwise, the interrupt control section 820 outputs “0” as the interrupt request signal. In the case where a plurality of interrupt requests occur, the interrupt control section 820 arbitrates the interrupt requests. When the debugger ON signal becomes “1”, the interrupt control section 820 also sets the interrupt request signal to “1”.

Herein, for simplicity of description, it is assumed that an operation code of an interrupt process (interrupt process routine) which is to be carried out when the debugger ON signal becomes “1” is stored in the unprotected region. Also, it is assumed that the final instruction of the interrupt process is a return instruction for returning the return address, which has been pushed to the stack, to the program counter (interrupt return instruction).

When the value of the interrupt request signal which is input to the CPU 110 becomes “1”, the CPU 110 stores a currently accessed address (program counter value), i.e., the CPU 110 pushes a currently accessed address to the stack, and outputs to the address bus B101 an address in which the operation code of the interrupt process is stored; Meanwhile, the CPU 110 sets the read enable signal to value “1” to start retrieval of the operation code of the interrupt process. The CPU 110 retrieves from the data bus B102 an operation code of a return instruction for returning the return address which has been pushed to the stack to the program counter and decodes the operation code to return the return address which has been pushed to the stack to the program counter and output the address to the address bus B101. Meanwhile, the CPU 110 sets the read enable signal to value “1”.

—Operation—

Next, an operation of the microcomputer 800 is described wherein the CPU 110 starts execution of an instruction while the external debugger 180 is not connected to the microcomputer 800, and the external debugger 180 is then connected to the microcomputer 800 in the midst of execution of the instruction, and thereafter, authentication is successfully done.

First, the operation of the microcomputer 800 during execution of the instruction which is carried out while the external debugger 180 is not connected to the microcomputer 800 is described.

In this period, the value of the data invalidation signal, which is the output of the Exclusive NOR circuit 530, is ”0” as in embodiment 6. Since the data invalidation signal is “0”, the data invalidation section 810 outputs the data of the ROM bus B103 to the data bus B102. Therefore, the CPU 110 retrieves an operation code of the data of the ROM bus B103 which has been output to the data bus B102, i.e., an operation code which is output from the internal nonvolatile memory 120, and decodes the operation code to execute the resultant instruction.

Next, the operation of the microcomputer 800 carried out during a period between connection of the external debugger 180 to the microcomputer 800 and success of authentication is described. In an instance described below, it is assumed that the CPU 110 is accessing address “100H” at the time when the external debugger 180 is connected to the microcomputer 800, and that the operation code of an interrupt process carried out when the debugger ON signal becomes “1” is stored in address 200H of the unprotected region.

When the external debugger 180 is connected to the microcomputer 800, the debugger ON signal becomes “1”, so that an interrupt request occurs. Accordingly, the interrupt control section 820 outputs “1” as the interrupt request signal. Since the interrupt request signal is “1”, the CPU 110 stores currently accessed address “100H” and stops retrieval of an operation code from address 100H. The CPU 110 outputs to the address bus B101 address “200H” in which the operation code of the interrupt process is stored, and sets the read enable signal to value “1”. Then, the CPU 110 starts retrieval of the operation code of the interrupt process. At this point in time, the value of the data invalidation signal is “1”, and the address output to the address bus B101 is address “200H” of the unprotected region. Therefore, the data invalidation section 810 outputs the data of the ROM bus B103 to the data bus B102. Thus, the CPU 110 retrieves the data of the ROM bus B103 which has been output to the data bus B102, i.e., the operation code of the interrupt process which has been output from the unprotected region of the internal nonvolatile memory 120, and decodes the operation code to execute the resultant instruction.

Now, the operation of the microcomputer 800 is described wherein, when the operation code retrieved from the unprotected region by the CPU 110 is an operation code of an instruction for reading of predetermined data from the protected region, the data of the protected region are protected from being read out.

The CPU 110 retrieves and decodes the operation code of an instruction for reading of predetermined data from the protected region, and for the purpose of reading the predetermined data, the CPU 110 outputs to the address bus B101 an address in which the predetermined data is stored and sets the read enable signal to “1”. Since the value of the data invalidation signal is “1” and the address output to the address bus B101 is an address indicative of a protected region of the internal nonvolatile memory 120, the data invalidation section 810 outputs to the data bus B102 an operation code which is supposed to be decoded by the CPU 110 into an instruction indicative that nothing is to be executed. Since the data of the protected region are not output to the data bus B102 during the period between connection of the external debugger 180 to the microcomputer 800 and success of authentication, the data of the protected region are not fraudulently read out from the external debugger 180 through the DMAC 141 or externally read out through execution of an instruction by the CPU 110.

Next, the operation of the microcomputer 800 carried out after a predetermined authentication procedure ends in success of authentication is described.

After success of authentication, the data invalidation signal is “0”, so that the data invalidation section 810 outputs the data of the ROM bus B103 to the data bus B102. The CPU 110 retrieves from the data bus B102 an operation code output from the internal nonvolatile memory 120 and decodes the operation code. In this way, the CPU 110 can read, after success of authentication, the data of the protected region from the internal nonvolatile memory 120.

Now, the operation of the microcomputer 800 is described wherein, after success of authentication, the CPU 110 resumes an access to address “100H” that the CPU 110 has been accessing at the time of connection of the external debugger 180 to the microcomputer 800.

During the period between connection of the external debugger 180 to the microcomputer 800 and success of authentication, the operation code output from the unprotected region is retrieved and decoded by the CPU 110, and the resultant instruction is executed by the CPU 110. The CPU 110 retrieves from the unprotected region the operation code of a return instruction for returning the return address which has been pushed to the stack to the program counter and decodes the operation code to output address “100H”, which has been stored at the time of connection of the external debugger 180 to the microcomputer 800, to the address bus B101 and set the value of the read enable signal to “1”. In this way, the CPU 110 resumes, after success of authentication, retrieval of the operation code of address “100H” that the CPU 110 has been accessing at the time of connection of the external debugger 180 to the microcomputer 800. Therefore, even when the external debugger 180 is connected to the microcomputer 800 in the midst of execution of the instruction by the CPU 110 as described above, i.e., even when so-called hot insertion or removal occurs, the CPU 110 can start debugging after success of authentication with the program counter value saved at the time of connection of the external debugger 180 to the microcomputer 800.

As described above, in this embodiment, the microcomputer 800 is configured such that whether data of the internal nonvolatile memory 120 is output to the data bus B102 depends on the address of the data as in embodiment 3. Therefore, with such a structure, even during a period between connection of the external debugger 180 to the microcomputer 800 and success of authentication, the CPU 110 is enabled to execute an operation code which needs no protection without the microcomputer 800 going haywire, while data which needs protection is protected against fraudulent read attempts. For example, an operation code of a process which needs to be promptly executed in whatever situation, such as an interrupt process, and the like, may be stored in an unprotected region.

The interrupt which occurs at the time of connection of the external debugger 180 to the microcomputer 800 may be a non-maskable interrupt such that, when the external debugger 180 is connected to the microcomputer 800, the interrupt process is infallibly executed without being prohibited or missed due to other interrupt factors. In this case, it is not necessary to add an additional function to the common interrupt control circuit, and the CPU 110 does not accept interrupts caused by other interrupt factors during the period between connection of the external debugger 180 to the microcomputer 800 and success of authentication as not in embodiment 4. Thus, a miss of the interrupt process due to other interrupt factors can be prevented.

This embodiment utilizes such a mechanism common to the general CPUs that an address that the CPU 110 is accessing at the time of occurrence of an interrupt is pushed to a stack, and the address is returned from the stack to the program counter at the time of execution of the return instruction. Therefore, it is not necessary to provide an additional circuit, and advantageously, the circuit area does not increase.

### Other embodiments

The microcomputers of the above-described embodiments may have a one-chip structure or may have a multiple-chip structure configured such that a signal transmitted through a bus between the CPU 110 and the internal nonvolatile memory 120 cannot be physically read out by an external device.

In embodiment 2, with the view of preventing interruption in the midst of a series of instructions of the internal nonvolatile memory 120 which should be continuously executed, protection against fraudulent read attempts is started after an operation code of a branch instruction is decoded, but the present invention is not limited to this arrangement. Specifically, embodiment 2 is enabling so long as protection against fraudulent read attempts is started after a timing when discontinuity in the execution of the series of instructions becomes acceptable. For example, the protection may be started at a timing when the interrupt request signal is input to the CPU 110 but is not masked.

In FIG. 3, FIG. 7 and FIG. 8 of embodiments 3, 7 and 8, the internal nonvolatile memory 120 are divided into two regions, but the present invention is not limited thereto. For example, the internal nonvolatile memory 120 may be divided into three or more regions. In each region, during a period between connection of the external debugger 180 to the microcomputer 300 and success of authentication, whether data can be read out is fixedly set but may be set variably. Specifically, whether data can be read out may be determined according to the value of a register which can be set by the I/O data bus B105. Alternatively, a plurality of internal nonvolatile memories may be used instead of dividing the internal nonvolatile memory 120 into a plurality of regions.

In embodiments 5, 6, 7 and 8, the data invalidation section 510, the data conversion section 720 and the data invalidation section 810 each output to the data bus B102 an operation code which is supposed to be decoded by the CPU 110 into an instruction indicative that nothing is to be executed, in place of the data of the ROM bus B103 output from the internal nonvolatile memory 120, whereby the data of the internal nonvolatile memory 120 are prevented from being read out by a device outside the internal nonvolatile memory 120. However, the present invention is not limited to these embodiments so long as the data of the internal nonvolatile memory 120 are prevented from being read out. For example, the data of the internal nonvolatile memory 120 may be prevented from being read out by preventing the read enable signal from being “1” or by preventing the address output by the CPU 110 from being input to the internal nonvolatile memory 120. Alternatively, predetermined data other than the operation code which is supposed to be decoded by the CPU 110 into an instruction indicative that nothing is to be executed may be output to the data bus B102 in place of the data of the ROM bus B103.

Although in the bus request holding section 520 of embodiment 5 the bus request holding signal is input to the Exclusive NOR circuit 530, the bus request signal may be directly input to the Exclusive NOR circuit 530 in place of the bus request holding signal. Specifically, in the case where the bus request holding section 520 is configured such that the bus request signal is directly input to the Exclusive NOR circuit 530, the data of the internal nonvolatile memory 120 enters the externally unreadable state at every timing when the DMAC 141 accesses the CPU 110, whereas in embodiment 5, once the DMAC 141 accesses the CPU 110, the data of the internal nonvolatile memory 120 cannot be externally read out before success of authentication.

In the example described in embodiment 5, protection of the data of the internal nonvolatile memory 120 is started at the start of DMA, but the present invention is not limited to this example. For example, the timing of starting protection may occur between connection of the external debugger 180 and the start of an operation through which data of the internal nonvolatile memory 120 to be protected can be externally read out under the control of the external debugger 180.

Alternatively, during a period between the start of an operation through which data of the internal nonvolatile memory 120 to be protected can be externally read out under the control of the external debugger 180 and success of authentication, the protected state may be entered for every period of such an operation instead of continuously maintaining the protected state.

In the case where the CPU 110 is stopped as in embodiment 6, the interrupt request signal may be masked by the interrupt control section as in embodiment 4.

In all of the above-described embodiments, the data output from the internal nonvolatile memory 120 is replaced by predetermined data by the data conversion section or data invalidation section, whereby the data of the internal nonvolatile memory 120 is prevented from being output to the outside of the microcomputer. However, the output of the data may be prevented by any other means. For example, data may be inhibited from being input from the external debugger 180 to the microcomputer and inhibited from being output from the microcomputer to the external debugger 180, and as a result, the data of the internal nonvolatile memory 120 is prevented from being output to the outside of the microcomputer.

In each embodiment, an NAND circuit may be used in place of the Exclusive OR circuit 170. Likewise, an AND circuit may be used in place of the Exclusive NOR circuit 530. In the case where the NAND circuit or AND circuit is used, the data of the internal nonvolatile memory 120 can be read out by an external device outside the microcomputer even after success of authentication, completion of debagging, and disconnection of the external debugger 180.

The components described in the above embodiments may be organized into various logically-acceptable combinations. For example, in any one of the microcomputer configurations of embodiments 1, 2, 3, 5, 6 and 7, interrupts may be masked during a period when the data of the internal nonvolatile memory 120 are protected against external read attempts as in embodiment 4. Alternatively, each of the microcomputers of embodiments 2, 4, 5 and 6 may be configured such that the data of the protected region of the internal nonvolatile memory 120 is protected against external read attempts while the data of the unprotected region can always be read out as in embodiment 3.

A microcomputer of the present invention provides such effects that information of a memory are protected against external read attempts during a period between connection of a debugger to the microcomputer and success of authentication, and that debugging can be started not with post-reset conditions but with normal operation conditions. For example, the present invention is useful as a technique for protecting programs and data stored in a nonvolatile memory, or the like, incorporated in a microcomputer against fraudulent read attempts.

What is claimed is:

1. A microcomputer, comprising:
a memory;
a CPU which decodes memory data stored in the memory to execute an instruction;
a debug control section for instructing the microcomputer to perform a debug operation according to an instruction from an external debug instruction device which is connected to the microcomputer; and
an authentication section for performing, when the external debug instruction device is connected to the microcomputer that is in a normal operation, an authentication as to whether to allow the debug operation to be performed,
wherein the memory data of the memory is prevented from being read out to outside of the microcomputer during a period between connection of the external debug instruction device to the microcomputer and success of the authentication by the authentication section.

2. The microcomputer of claim 1, further comprising a memory control section which prevents the memory data from being output from the memory within the microcomputer during a period between connection of the external debug instruction device to the microcomputer that is in a normal operation and success of the authentication by the authentication section.

3. The microcomputer of claim 2, wherein the memory control section causes the memory to output predetermined data irrespective of the memory data, thereby preventing the memory data from being output from the memory within the microcomputer.

4. The microcomputer of claim 3, wherein the predetermined data is data which is supposed to be decoded by the CPU into an instruction for branching to a region where a relative address is 0.

5. The microcomputer of claim 4, further comprising a branch instruction detection section for detecting execution of a branch instruction by the CPU, wherein
after connection of the external debug instruction device to the microcomputer, the memory control section causes the memory to output the predetermined data during a period between detection of a branch instruction by the branch instruction detection section and success of the authentication.

6. The microcomputer of claim 4, further comprising a protected region access detection section for detecting an access to a predetermined protected region of the memory, wherein
after connection of the external debug instruction device to the microcomputer, the memory control section causes the memory to output the predetermined data after detection of an access to the protected region.

7. The microcomputer of claim 6, wherein an instruction of an interrupt process is stored in a region of the memory other than the protected region.

8. The microcomputer of claim 4, further comprising an interrupt control section for masking an interrupt request signal input to the CPU during a period when the memory control section causes the memory to output the predetermined data.

9. The microcomputer of claim 3, wherein the predetermined data is data which is supposed to be decoded by the CPU into an instruction indicative that nothing is to be executed.

10. The microcomputer of claim 3, further comprising a direct memory access controller which accesses the memory without the intervention of the CPU, wherein
when the direct memory access controller accesses the memory during the period between connection of the external debug instruction device to the microcomputer and success of the authentication, the memory control section causes the memory to output the predetermined data.

11. The microcomputer of claim 2 wherein, after connection of the external debug instruction device to the microcomputer, the memory control section prevents the memory data from being output from the memory within the microcomputer after a predetermined timing.

12. The microcomputer of claim 11, wherein the predetermined timing is a timing when discontinuity in execution of a series of instructions becomes acceptable.

13. The microcomputer of claim 12, wherein the timing when discontinuity in execution of a series of instructions becomes acceptable is a timing when an interrupt request signal to the CPU is not masked.

14. The microcomputer of claim 12, wherein the predetermined timing is a timing when the CPU executes a branch instruction.

15. The microcomputer of claim 11, wherein the predetermined timing is a timing when the CPU accesses a predetermined protected region of the memory.

16. The microcomputer of claim 11, further comprising a direct memory access controller which accesses the memory without the intervention of the CPU, wherein
the predetermined timing is a timing when the direct memory access controller starts accessing the memory.

17. The microcomputer of claim 2 wherein, after connection of the external debug instruction device to the microcomputer, the memory control section prevents the memory data from being output from the memory within the microcomputer at every predetermined timing.

18. The microcomputer of claim 17, wherein the predetermined timing is a timing when the CPU accesses a predetermined protected region of the memory.

19. The microcomputer of claim 18 wherein, in a first read cycle after connection of the external debug instruction device to the microcomputer that is in a normal operation, the memory control section causes the memory to output, in substitution for the memory data, data which is supposed to be decoded by the CPU into an instruction for branching to a predetermined subroutine.

20. The microcomputer of claim 19, wherein a last instruction of the predetermined subroutine is a return instruction for returning a return address from a stack to a program counter.

21. The microcomputer of claim 18 wherein, when the external debug instruction device is connected to the microcomputer that is in a normal operation, the CPU executes an interrupt process.

22. The microcomputer of claim 21, wherein a last instruction of the interrupt process is a return instruction for returning a return address from a stack to a program counter.

23. The microcomputer of claim 21, wherein the interrupt which occurs in the CPU is a non-maskable interrupt.

24. The microcomputer of claim 17, further comprising a direct memory access controller which accesses the memory without the intervention of the CPU, wherein
the predetermined timing is a timing when the direct memory access controller accesses the memory.

25. The microcomputer of claim 2, further comprising a protected region access detection section for detecting an access to a predetermined protected region of the memory, wherein
after connection of the external debug instruction device to the microcomputer, the memory control section prevents memory data stored in the protected region from being output from the memory within the microcomputer during a period when an access to the protected region is detected.

26. The microcomputer of claim 2, wherein an interrupt request signal input to the CPU is masked during the period between connection of the external debug instruction device to the microcomputer that is in a normal operation and success of the authentication.

27. The microcomputer of claim 1, wherein the debug control section stops an operation of the CPU during a period between connection of the external debug instruction device to the microcomputer that is in a normal operation and success of the authentication.

28. The microcomputer of claim 27, further comprising an interrupt control section which masks an interrupt request signal input to the CPU during a period when the operation of the CPU is stopped.

29. The microcomputer of claim 1, wherein the debug control section prevents data from being output from the microcomputer to the external debug instruction device during a period between connection of the external debug instruction device to the microcomputer that is in a normal operation and success of the authentication.
